(19) United States
(12) Patent Application Publication
(10) Pub. No.: US 2024/0164564 A1
(43) Pub. Date: May 23, 2024

(54) Gas Heat Exchanger with Baffle for a Combination Oven

(71) Applicant: Alto-Shaam, Inc., Menomonee Falls, WI (US)

(72) Inventors: Jon Paul Flick, Wales, WI (US); Craig Douglas Burnett, Slinger, WI (US)

(21) Appl. No.: 18/516,211

(22) Filed: Nov. 21, 2023

Related U.S. Application Data
(60) Provisional application No. 63/427,203, filed on Nov. 22, 2022.

(51) Int. Cl. A47J 27/00; A47J 36/04; A47J 36/16

(52) U.S. Cl. CPC A47J 27/002; A47J 36/04; A47J 36/16; A47J 2027/043; A47J 2201/00

(57) ABSTRACT

The present invention provides a combination oven providing combination steam and convection cooking. The cooking cavity is heated by a heat exchanger system that includes at least one heat exchanger tube. Heat transfer along a length of the heat exchanger tube is facilitated by a heat conductive baffle substantially filling the interior of the heat exchanger tubes in volume and length. Heated gases are forced through the dense and elongated baffle to facilitate heat transfer to the walls of the heat exchanger tube.

### CROSS REFERENCE TO RELATED APPLICATION

This application claims the benefit of U.S. Provisional Patent Application No. 63/427,203, filed Nov. 22, 2022, which is incorporated by reference herein in its entirety.

### BACKGROUND OF THE INVENTION

The present invention relates to a gas heat exchanger for a combination oven, and in particular to a gas heat exchanger with a blower and a heat exchanger tube holding a baffle insert.

Combination steam and convection ovens (“combi-ovens”) cook using combinations of convection and steam. In convection cooking, heated air is circulated rapidly through the cooking compartment to break up insulating layers of air around the food, thereby increasing the rate of heat transfer. Steam enhances the rate of heat transfer to the food as a result of the high specific heat of water compared to dry air and can also reduce water loss from the food.

Combi-ovens are described, for example, in U.S. Pat. Nos. 6,188,045; 6,987,246; 7,307,244; 9,372,005; 9,677,774; 9,879,865; 10,088,172; 10,088,173; 10,337,745; 10,684,022; and 10,842,320 assigned to the assignee of the present invention and hereby incorporated by reference.

### SUMMARY OF THE INVENTION

The present invention further improves over the prior art by providing combi-ovens or multi-cook ovens with a heat exchanger system which mix the combustion air with the fuel gas prior to ignition (i.e., a “pre-mix” system) and guides the premixed gases through a heat exchanger tube. The heat exchanger tube contains a burner producing a flame within the heat exchanger tube and receiving the premixed gases to create heated flue gases. Heat transfer along the length of the heat exchanger tube or tubes is facilitated by a heat conductive baffle material substantially filling the volume of the heat exchanger tube or tubes along the heated air pathway. Heated flue gases are forced through the dense and elongated baffle by a blower as taught herein.

A baffle made of, for example, silicon carbide is inserted into a combi oven heat exchanger tube and optionally multiple heat exchanger tubes of the heat exchanger system. The heated flue gases of the burner interact with the inserted baffle to increase the convection on the inside or inner surface of the heat exchanger tubes, allowing the inside or inner surface of the heat exchanger tubes to increase in temperature and provide improved heat transfer compared to heat exchanger tubes without the baffle, i.e., silicon carbide insert. The silicon carbide insert may be a preferred baffle material since it is durable, long lasting and thus more reliable than other metal inserts or materials. The increased heat transfer provided by the baffle allows the heat exchanger tubes to be smaller, thus reducing the overall footprint of the combi oven.

The present invention provides a combination oven comprising an insulated housing including a door configured to close to define an interior cooking cavity and an opening to provide access to the cooking cavity; a steam generator for producing steam within the cooking cavity according to a steam production signal; a cooking cavity heater system communicating with the cooking cavity to heat the cooking cavity and comprising a blower adapted to receive air and gas and deliver mixed air and gas downstream to the at least one combustion tube; a gas burner producing a flame to heat the mixed air and gas; and an internal baffle positioned within the at least one combustion tube to conduct heat from heated air and gas passing through the combustion tube to walls of the combustion tube and extending from an inlet to an outlet of the combustion tube along a longitudinal axis extending along a length of the combustion tube.

It is thus a feature of at least one embodiment of the present invention to increase the convection on the inner surface of the heat exchanger tubes, allowing the tube wall to increase in temperature, and thus provide improved heat transfer to the air inside the oven compared to a tube without the silicon carbide insert.

The internal baffle may be thermally conductive and in direct contact with an inner surface of the combustion tube to conduct heat thereto.

It is thus a feature of at least one embodiment of the present invention to facilitate heat conduction from the heated air passing through the heat tube to the walls of the heat tube.

The internal baffle may extend across a diameter of the combustion tube in at least two perpendicular directions. The internal baffle may extend across a diameter of the combustion tube in at least four perpendicular directions.

It is thus a feature of at least one embodiment of the present invention to increase the heat transfer surface area using a smaller shape or form factor for increased heat transfer to the heat tube in a confined area.

An internal volume of the combustion tube may be at least 60% filled by a volume of the internal baffle. An internal volume of the combustion tube may be at least 70% filled by a volume of the internal baffle. An internal volume of the combustion tube may be at least 80% filled by a volume of the internal baffle.

The length of the combustion tube may be at least 60% filled by a length of the internal baffle. The length of the combustion tube may be at least 70% filled by a length of the internal baffle. The length of the combustion tube may be at least 80% filled by a length of the internal baffle.

It is thus a feature of at least one embodiment of the present invention to permit the reduction of tube size by increasing the heat transfer rate.

The internal baffle may be formed by a curved plate winding about a baffle axis to form a helicoid. The internal baffle may provide a helical channel conducting the heated air and gas in a helical path winding about the baffle axis of the internal baffle as it moves along the longitudinal axis from the inlet to the outlet of the combustion tube.

It is thus a feature of at least one embodiment of the present invention to reduce bypass effects, reduce fouling, prevent flow-induced vibration, and reduce maintenance/cleaning. The internal baffle material may be silicon carbide. The internal baffle may have a conductivity of at least 15.2 W/(m-K). The internal baffle may have a density of approximately 2.7 to 3.0 g/cm³. The internal baffle may weigh approximately 500 to 900 g and have a volume of 200 to 300 cc.

It is thus a feature of at least one embodiment of the present invention to use a baffle material that is durable and long lasting. It is also a feature of at least one embodiment of the present invention to select baffle materials that can withstand the high heat from the heated air but also impingement heat from the burner assembly.

An outer footprint of the combustion tube may be cylindrical. First and second end plates may be attached to opposed ends of the internal baffle respectively and form attachment collars at the opposed end of the internal baffle.

It is thus a feature of at least one embodiment of the present invention to allow the baffle to fit within the combustion tube in a fixed attachment using fasteners.

The combustion tube may be at least one of aluminum, copper alloy, stainless steel, carbon steel, non-ferrous copper alloy, Inconel, nickel, Hastelloy and titanium.

These particular objects and advantages may apply to only some embodiments falling within the claims and thus do not define the scope of the invention.

### BRIEF DESCRIPTION OF THE FIGURES

FIG. 1 is a simplified perspective view of an oven in partial cutaway showing a heat exchanger system of the present invention having an upper section and a lower section;

FIG. 2 is an exploded view of an exemplary heat exchanger of a heat exchanger system;

FIG. 3 is a cross-sectional view of the heat exchanger system of FIG. 1 taken at line 3-3 of FIG. 1;

FIG. 4A is a side elevation view of one embodiment of the baffle insert of the heat exchanger system of FIG. 1 showing a helicoid baffle without end attachment collars;

FIG. 4B is a side elevation view of a second embodiment of the baffle insert of the heat exchanger system of FIG. 1 showing a helicoid baffle with end attachment collars; and

FIG. 5 is a top plan view of the baffle insert of FIG. 4B showing the fins of the helicoid baffle connected to the end collar.

### DETAILED DESCRIPTION OF THE PREFERRED EMBODIMENT

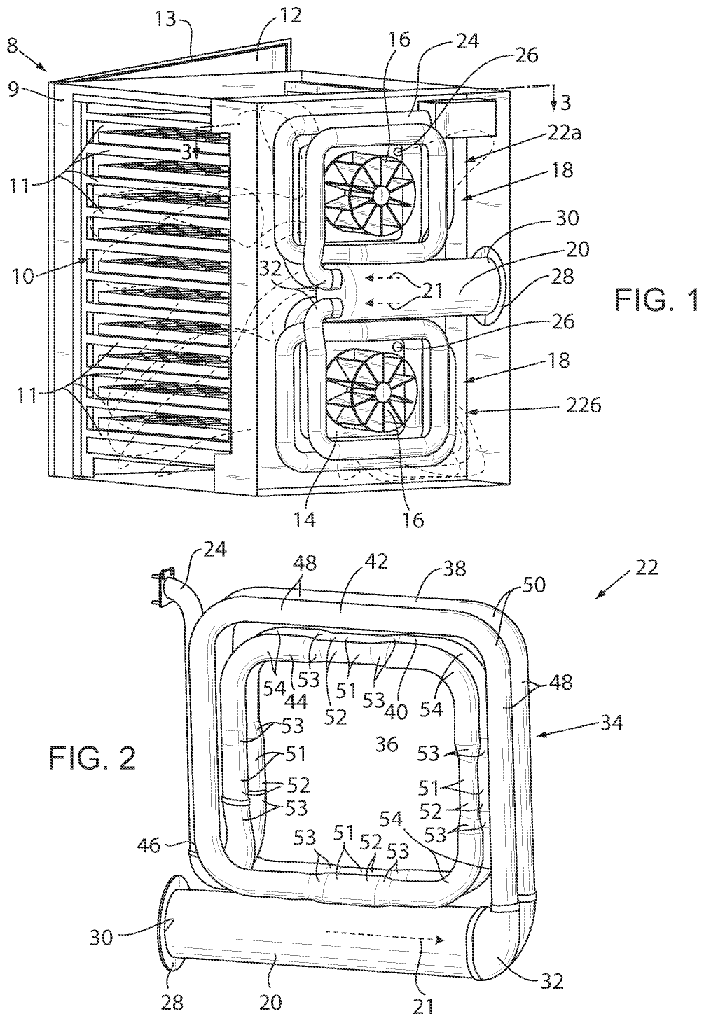

Referring now to FIG. 1, a combination oven 8, shown in a simplified and mostly schematic manner, is suitable for providing steam and convection air cooking as controlled by a controller (not shown) in a known manner. The combination oven 8 includes a housing 9 that defines a cooking volume 10 which is open toward a front of the housing 9.

In one embodiment, cooking volume 10 is accessible through a door 12 including a glass vision panel, the door 12 connected by a hinge at one vertical side of the housing 8 to sealingly or otherwise close the cooking volume 10 during cooking operations. A gasket 13 may be provided in some embodiments to surround an opening of the cooking volume 10, covered by the door 12. A latch assembly (not shown) allows the door 12 to compress the gasket and be retained in what may be a sealed position or to be released to allow the door 12 to open. A door sensor 15, for example, a micro switch, may provide a signal indicating whether the door 12 is open or closed by the latch assembly.

The cooking volume 10 may carry multiple cooking racks 11 positioned in vertical separation within the cooking volume 10 to hold trays of food items. The sidewalls of the cooking volume 10 may provide for rack support rails holding the cooking racks 11, providing open shelves arranged vertically in spaced parallel relationship. In certain embodiments of the cooking volume 10, the cooking volume 10 may be separated into vertically stacked cooking cavities where horizontal humidity barriers or walls limit the exchange of moisture and airflow between cooking cavities. The cooking cavities may be independently temperature and steam controlled to provide for different cooking operations within each cooking cavity.

Positioned within the housing 9 and communicating with the cooking volume 10 through a perforated panel 14 (for example, at a rear of the cooking volume 10) is at least one convection fan 16 forcing air in a radial direction away from the fan 16, past the heat source 18 which may include heat exchanger 22, and into the cooking volume 10 to provide heat for cooking food items in the cooking volume 10. The heat source 18 or heat exchanger 22 includes a combustion tube 20, which may be a cylindrical tube 20 oriented vertically, horizontally, or diagonally, and in which gas combustion occurs in a known manner to provide heated flue gases 21 that are directed through at least one heat exchanger 22 which is connected to an end of the combustion tube 20. The combustion tube 20 may be 14 inches long with a 3.5 inch outer diameter and 3.38 inch inner diameter. However, the lengths and diameters of the combustion tube 20 may vary.

The combustion tube 20 may connect to one or more splitters 32 which direct the heated flue gases 21 to at least one heat exchanger 22, for example, upper and lower heat exchangers 22a, 22b, of the heat exchanger system. The at least one heat exchanger 22 wrap around the fan 16 twice and direct the flue gases along a generally coiled path about the fan 16, explained in greater detail herein, and out of an outlet tube 24 that is connected to ductwork (not shown) for exhausting the flue gases 21.

Still referring to FIG. 1, the heat source 18 may further provide heat for the production of steam produced by a water jet 26 controlled by a valve (not shown) typically impinging on or near the fan 16 and a portion of the convection heating source 18 proximate to the fan 16. One or more thermal sensors, for example, platinum RTDs (Resistance Temperature Detectors) or thermocouple elements, may communicate with the cooking volume 10 to provide an electrical signal indicating a temperature within that volume 10. Alternatively, heat to produce steam may be provided by a separate independent steam heating element, apart from the heat source 18, which can be separately controlled. In this respect, the independent steam heating element may be impinged by the water jet 26 to produce steam. The steam heating element may be as described in U.S. patent application Ser. No. 17/840,073, assigned to the present applicant and hereby incorporated by reference.

Ovens of this type are commercially available from Alto-Shaam Inc. of Menomonee Falls, Wis., and are described generally in U.S. Pat. Nos. 6,188,045; 6,987,246; 7,307,244; 9,372,005; 9,677,774; 9,879,865; 10,088,172; 10,088,173; 10,337,745; 10,684,022; 10,729,144; 10,842,320; 10,986,843, and hereby incorporated by reference.

Referring now to FIG. 2, the at least one heat exchanger 22 may be made from stainless steel or other suitable metal materials, which may be provided as interconnected tube segments that may be interconnected by welding around the entire periphery of the abutting or otherwise engaging ends of the tube segments to provide a fluid-tight connection therebetween. The heat exchanger 22 is supported in a suspended manner by engagements of the outlet tube 24 and a flange 28 to walls of the housing 8. A flange 28 is provided at an inlet end 30 of the combustion tube 20. A passage through the flange 28 and the inlet end 30 provide a routing path through which gas plumbing lines, which deliver gas to a burner assembly 60, and electrical conductors that are operably connected to an igniter 62 within the combustion tube 20 extend, as further described below.

A splitter 32 is connected to a gas outlet end 64 of the combustion tube 20 and has a circular shaped inlet with a relatively larger diameter and two outlets that have circular shapes with a relatively smaller diameter. The two outlets are approximately the same size and are arranged generally perpendicularly to the inlet of the splitter 32. The heat exchanger 22 extends from the splitter 32 and includes an outer loop 34 and an inner loop 36. Each of the outer and inner loops 34, 36 includes a pair of hoops made from tubing, shown as back hoops 38, 40, and front hoops 42, 44 for the outer and inner loops 34, 36, respectively.

The back hoops 38, 40 of the outer and inner loops 34, 36 are connected to each other so that a continuously looping passage is provided that defines a first flow path through the heat exchanger 22. The first flow path extends from the combustion tube 20 through a back outlet of the splitter 32 and continuously and sequentially through the outer loop, back hoop 38 and the inner loop back hoop 40, then through a back inlet of a collector 46 that is connected to the outlet tube 24. The front hoops 42, 44 of the outer and inner loops 34, 36 are connected to each other so that a continuously looping passage is provided that defines a second flow path through the heat exchanger 22. The second flow path extends from the combustion tube 20 through a front outlet of the splitter 32 and continuously and sequentially through the outer loop, front hoop 42 and the inner loop, front hoop 44, then through a front inlet of the collector 46 so the first and second flow paths merge in the collector 46 and the combined volume is directed out of the combination oven 8 through the outlet tube 24.

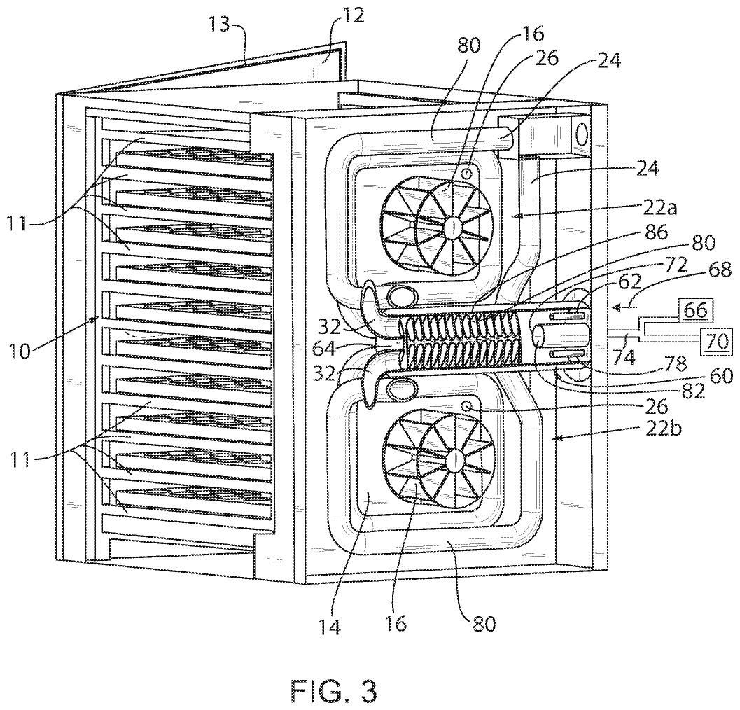

Still referring to FIG. 2, the outer loop, back and front hoops 38, 42 may be provided by tube segments that are made from lengths of round tubing stock, for example, 1⅝ inch or 1¾ inch outer diameter tubing. Each of the outer loop, back and front hoops 38, 42 includes straight sections 48 and curved sections 50. As shown in FIGS. 2 and 3, the curved sections 50 are shown as being curved at about 90 degrees to provide rounded corners between respective pairs of straight sections 48. In this way, adjacent straight sections 48 are arranged at about 90 degrees with respect to each other so that the outer loop 34 provides a generally rectangular arrangement at the outside of the heat exchanger 22. The straight sections 48 at the ends of the outer loop, back and front hoops 38, 42 that connect to the inner loop, back and front hoops 40, 44 may be substantially shorter than other straight sections 48 within the outer loop 34.

Referring again to FIG. 2, the inner loop, back and front hoops 40, 44 may be provided by tube segments that are made from lengths of round tubing stock which may have the same diameter(s) as the outer loop, back and front hoops 38, 42, for example, 15% inch to 1¾ inch outer diameter tubing. Each of the inner loop, back and front hoops 40, 44 includes straight sections 51 and curved sections 54. A tube segment that provides a flattened portion 52 of the straight section 51 and that extends longitudinally between respective pairs of the transition portions 53. The entire flattened portion 52 provided between the pair of transition portions 53 may each be produced from a piece of round tubing stock material that is squeezed in a press to partially collapse the piece(s) of round tubing stock material in a transverse direction.

As shown in FIGS. 2 and 3, like the curved sections within the outer loop 34, the curved sections 54 of the inner loop, back and front hoops 40, 44 are shown as being curved at about 90 degrees to provide rounded corners between respective pairs of straight sections 51, so that adjacent straight sections 51 are arranged at about 90 degrees with respect to each other so that the inner loop 36 provides a generally rectangular arrangement at the inside of the heat exchanger 22, closer to the fan 16 (FIG. 1) than the outer loop 34.

It is understood that the tube segments of the at least one heat exchanger 22 may vary in configuration. For example, the splitter 32 may extend initially to the inner loop 36 and then further extend to the outer loop 34 as shown in FIG. 1 as opposed to the splitter 32 extending initially to the outer loop 34 and then further extend to the inner loop 36 as shown in FIG. 2. There may also be one or more heat exchanger 22 of the heat exchanger system extending from the combustion tube 20, and thus the splitter 32 may split the path from the combustion tube 20 to one or more heat exchangers 22. For example, the splitter 32 extends to two heat exchangers 22a and 22b with two convection fans 16 as shown in FIGS. 1 and 3, and the splitter 32 extends to one heat exchanger 22 as shown in FIG. 2. There may also be one or more combustion tubes 20 of the heat exchanger system or heat source 18 within the combination oven 5.

The combustion tube 20 material may be selected to have good thermal conductivity and strength since thermal stresses may occur during operation because of thermal expansion/contraction of the tube material and stresses from the high pressure of the heated flue gases 21. The combustion tube 20 material may be selected for compatibility with both the internal and external fluids for long periods of time under the operating conditions (i.e., temperatures, pressures, pH, etc.) to minimize deterioration such as corrosion. It is desired that the combustion tube 20 material is strong, thermally conductive, and corrosion resistant. The combustion tube 20 material may be metal, including, stainless steel or carbon steel, aluminum, copper alloy, non-ferrous copper alloy, Inconel, nickel, Hastelloy and titanium. Fluoropolymers such as Perfluoroalkoxy alkane (PFA) and Fluorinated ethylene propylene (FEP) may also be used due to their high resistance to extreme temperatures.

Referring to FIG. 3, in one embodiment, the combustion tube 20 supports the burner assembly 60 which provides a gas valve system with a pre-mix burner 66 which mixes gas and forced air and then propels the premixed gases 68 under the influence of forced air from a blower 70 to a burner tube 72 prior to ignition (this contrasts with an induced draft system in which the air is pulled through the burner tube from the opposite end of the burner tube by convection up the exhaust flue). The higher mixture pressures developed by the pre-mix burner 66 enable greater combustion volumes into the combustion space.

Specifically, the pre-mix burner 66 mixes natural gas or propane with air from the blower 70. After mixing, the premixed gases 68 travel through a common manifold 74 to the burner tube 72. The burner tube 72 is arranged within the combustion tube 20. The diameter of the burner tube 72 is less than the combustion tube 20 so that there is clearance around the burner tube 72. In one embodiment, the burner tube 72 may be approximately 4 inches long with a 1⅝ to 1¾ inch diameter. The burner tube 72 may be made of a material that can accommodate a gas firing rate of 5000-7000 btu/square inch. For example, the material of the burner tube 72 may be a woven ceramic matrix (Nextel 312) or NiCrAl metal foam.

Extending adjacent to and along the burner tube 72 may be an igniter 62, for example, a spark igniter 62 and a flame sensing rod 78. The spark igniter 62 produces a spark causing the premixed gases 68 traveling through the burner tube 72 and exiting the burner tube 72 to ignite and produce a flame. Alternatively, the burner tube 72 may include an igniter 62 that is a hot surface igniter 62 which will heat up, for example, a silicon carbide rod and/or flat plate, to a sufficiently high temperature to produce a spark that lights the premixed gases 69 traveling through the burner tube 72 and exiting the burner tube 72 to produce a flame. The flame sensing rod 78 may sense the flame and send signals to an ignition safety module to control when the gas valves are opened or closed.

It is understood that the pre-mix burner 66 generally produces a shorter and tighter flame than atmospheric (venturi) burners. The smaller surface area of the pre-mix burner 66 and its higher gas firing rate operate generally in radiant mode (versus blue flame mode). The radiant mode of the flame generally will heat only approximately the first four inches of the combustion tube 20 while heat is lost through the remaining length of the combustion tube 20. To keep the thermal efficiency of the burner assembly 60 high, the present invention further provides an internal baffle 80 that is installed within the combustion tube 20 downstream from the burner tube 72 as further described below.

The internal baffle 80 is positioned within the combustion tube 20 to conduct heat from the heated flue gases 21 passing through the combustion tube 20 from an outlet end 82 of the burner tube 72 to the gas outlet 64 of the combustion tube 20 and through the walls 86 of the combustion tube 20 itself. The outlet end 82 of the burner tube 72 is positioned upstream from the internal baffle and the gas outlet 64 of the combustion tube 20 is positioned downstream from the internal baffle 80.

The location of the internal baffle 80 within the combustion tube 20 may vary. In one embodiment, the internal baffle 80 may abut the outlet end 82 of the burner tube 72, or alternatively, the internal baffle 80 may be spaced as much as 3 inches or as much as 6 inches away from the outlet end 82 of the burner tube 72. The shorter length of the premix burner flame allows the internal baffle 80 to be positioned closer to the outlet end 82 of the burner tube 72 than with a longer flame because the shorter flame will not hit the internal baffle 80 and thus quench the flame and/or cause incomplete combustion. Thus, the internal baffle 80 may be desirably positioned within approximately 2 inches from the outlet end 82 of the burner tube 72.

Referring specifically to FIG. 5, as the heated flue gases 21 travel down the combustion tube 20, the heated flue gases 21 are forced to impinge the internal baffle 80. The internal baffle 80 is shaped and sized to substantially fill the space within the combustion tube 20 and may fill substantially an entire cross-sectional area and length of the combustion tube 20 so that the internal baffle 80 is distributed substantially evenly within the combustion tube 20, and desirably at a high density.

In one embodiment, the internal baffle 80 may extend substantially across an entire diameter (within 0.5 inches of the diameter) of the combustion tube 20, and in at least two perpendicular directions and in at least four perpendicular directions. The length of the combustion tube 20 may be at least 60%, 70%, or 80% filled by a length of the internal baffle 80. The length of the combustion tube 20 between the outlet end 82 of the burner tube 72 and gas outlet 64 of the combustion tube 20 may be at least 90% filled by a length of the internal baffle 80. An internal volume of the combustion tube 20 may be at least 60%, 70%, or 80% filled by a volume of the internal baffle 80.

The internal baffle 80 may be thermally conductive and may physically contact the inner surface of the wall 86 of the combustion tube 20 to conduct heat thereto. For example, the outer edges or outer boundary of the internal baffle 80 may provide a conductive physical connection with the inner surface of the combustion tube 20.

Still referring to FIG. 3, in one embodiment, the internal baffle 80 may be further positioned within one or more tubes of the at least one heat exchanger 22. For example, the internal baffle 80 may be positioned within adjacent straight sections 48 of the outer loop back and front hoops 38, 42 or within the adjacent straight sections 51 of the inner loop, back and front hoops 40, 44. It is understood that the internal baffle 80 may be positioned within any of the tubes of the at least one heat exchanger 22 to be oriented horizontally, vertically, or diagonally within the tubes. In a similar manner as described above with respect to the internal baffle 80 positioned within the combustion tube 20, the internal baffle 80 is shaped and sized to substantially fill the space within the tubes of the at least one heat exchanger 22.

While the combustion tube 20 is shown as having a generally circular cross-section, the internal baffle 80 may be used in tubes of different cross sectional shapes, for example, oval or rectangular, with the internal baffle 80 similarly shaped to fill substantially an entire cross section of the combustion tube 20 or tube of the heat exchanger 22.

The baffle 80 may be constructed as described below in the following exemplary embodiments.

### Examples

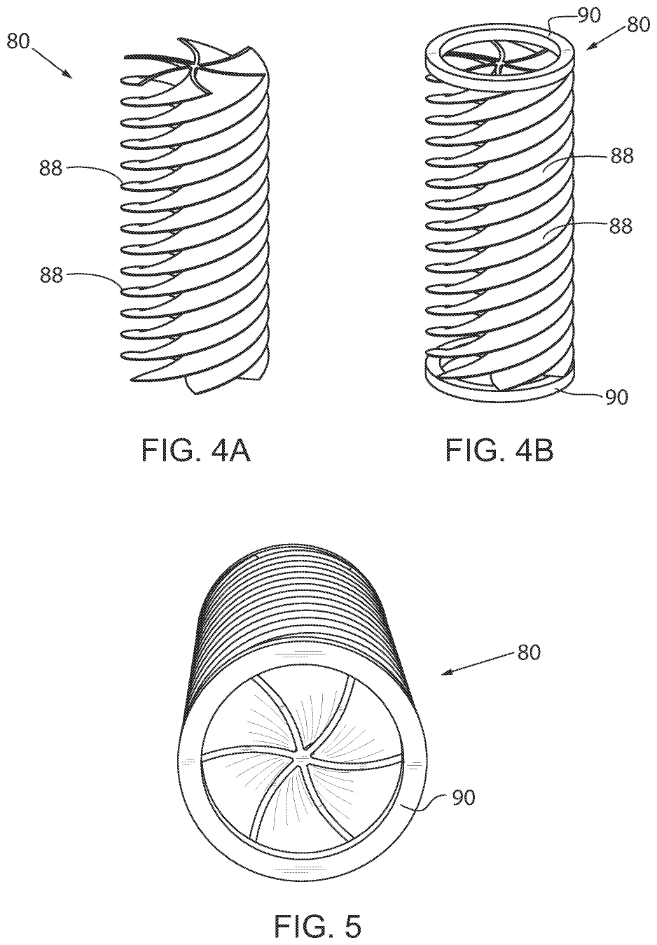

Referring to FIGS. 4 and 5, the internal baffle 80 may be constructed of a flame and oxidation resistant material, for example, silicon carbide or Kanthal type material. The material of the internal baffle 80 is desirably durable and long lasting. The material of the internal baffle 80 may have a conductivity of at least 15.2 W/(m-K). The material of the internal baffle 80 may generally be equal to or more conductive than ordinary glass (>0.8 W/(m-K)). The internal baffle 80 may weigh approximately 500 to 900 g and have a volume of 200 to 300 cc. The material of the internal baffle 80 may have a density of approximately 2.7 to 3.0 g/cm³.

The material of the internal baffle 80 may be generally porous and/or the configuration of the internal baffle 80 air penetrable thus providing openings or passageways to allow the heated flue gases 21 to pass through the internal baffle 80, yet dense enough to maximize heat transfer from the heated flue gases 21 to the walls 86 of the combustion tube 20 or tubes of the at least one heat exchanger 22. Generally, the blower 70 must be able to force the heated flue gases 21 through the baffle 80, and therefore, the density and porosity of the internal baffle 80 may be determined based on the force of the blower 70.

The porosity of the internal baffle 80 material may vary in different embodiments but will typically be homogenous within a given embodiment while the heat conductive material generally encompasses greater than 50% of the volume compared to air.

As seen in FIGS. 4A and 4B, one embodiment of the invention provides a helical baffle 80 formed in a helical or helicoid configuration. The helical baffle 80 may form air passageways where the heated flue gases 21 are conducted along a spiral pathway as the heated flue gases 21 pass through the helical baffle 80, for example, between the outlet end 82 of the burner tube 72 and gas outlet 64 of the combustion tube 20.

The helical baffle 80 may provide a plurality of spiraled fins 88 increasing the surface area within the combustion tube 20 and increasing the turbulence within the combustion tube 20. The fins 88 may have an inclination angle of approximately 40 degrees.

In one embodiment, as seen in FIG. 4B, the opposed, outer ends of the helical baffle 80 may be flanked by a pair of collar rings 90 to seal the ends of the helical baffle 80 to, for example, the inner surface of the walls 86 of the combustion tube 20 to direct the flow of heated flue gases 21 through the spiral air path created by the fins 88 of the helical baffle 80 instead of around the outside of the helical baffle 80 between the helical baffle 80 and the walls 86 of the combustion tube 20.

The collar rings 90 may support holes 92 allowing fixed attachment to the inner surface of the walls 86 of the combustion tube 20, for example, by bolts or screws, and thus preventing the helical baffle 80 from moving or rotating within the combustion tube 20 as the high velocity heated flue gases 21 pass through the combustion tube 20.

The helical baffle 80 may be approximately 4 to 8 inches in length with a 3 to 5 inch diameter and no more than 5 inches in diameter and no more than 4.75 inches in diameter, thus matching (within 0.5 inches) the inner diameter of the combustion tube 20 and encompassing substantially the entire cross sectional area of the combustion tube 20. In a similar manner, the helical baffle 80 may be approximately 4 to 8 inches in length with a 1⅝ to 1¾ inch diameter and no more than 1.85 inches in diameter and no more than 1.4 inches in diameter, thus matching (within 0.5 inches) the inner diameter of the tubes of the heat exchanger 22 and thus substantially encompassing the entire cross sectional area of the tubes of the heat exchanger 22.

It has been found that the use of the internal baffle 80 within the combustion tube 20 and/or one or more tubes of the at least one heat exchanger 22 has been shown to improve thermal efficiency by as much as 20% to 40% and at least 30% and at least 35% over non-baffle systems. It is understood that other parameters such as burner tuning, excess air, convection fan geometry, directional panel geometry, food loading, and the like may also affect thermal efficiency.

It is understood that any combination of baffle shape/configuration, baffle material, and/or features may be chosen from the above exemplary embodiments of the present invention. The present invention is not limited to the embodiments described herein.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A combination oven comprising:
an insulated housing including a door configured to close to define an interior cooking cavity and an opening to provide access to the cooking cavity;
a steam generator for producing steam within the cooking cavity according to a steam production signal;
a cooking cavity heater system communicating with the cooking cavity to heat the cooking cavity and comprising:
a blower adapted to receive air and gas and deliver mixed air and gas downstream to the at least one combustion tube;
a gas burner producing a flame to heat the mixed air and gas; and
an internal baffle positioned within the at least one combustion tube to conduct heat from heated air and gas passing through the combustion tube to walls of the combustion tube and extending from an inlet to an outlet of the combustion tube along a longitudinal axis extending along a length of the combustion tube;

2. The combination oven of claim 1 wherein the internal baffle is thermally conductive and in contact with an inner surface of the combustion tube to conduct heat thereto.

3. The combination oven of claim 1 wherein the internal baffle extends across a diameter of the combustion tube in at least two perpendicular directions.

4. The combination oven of claim 3 wherein the internal baffle extends across a diameter of the combustion tube in at least four perpendicular directions.

5. The combination oven of claim 1 wherein an internal volume of the combustion tube is at least 60% filled by a volume of the internal baffle.

6. The combination oven of claim 5 wherein an internal volume of the combustion tube is at least 70% filled by a volume of the internal baffle.

7. The combination oven of claim 6 wherein an internal volume of the combustion tube is at least 80% filled by a volume of the internal baffle.

8. The combination oven of claim 1 wherein the length of the combustion tube is at least 60% filled by a length of the internal baffle.

9. The combination oven of claim 8 wherein the length of the combustion tube is at least 70% filled by a length of the internal baffle.

10. The combination oven of claim 9 wherein the length of the combustion tube is at least 80% filled by a length of the internal baffle.

11. The combination oven of claim 1 wherein the internal baffle is formed by a curved plate winding about a baffle axis to form a helicoid.

12. The combination oven of claim 1 wherein the internal baffle provides a helical channel conducting the heated air and gas in a helical path winding about the baffle axis of the internal baffle as it moves along the longitudinal axis from the inlet to the outlet of the combustion tube.

13. The combination oven of claim 1 wherein the internal baffle material is silicon carbide.

14. The combination oven of claim 1 wherein the internal baffle has a conductivity of at least 15.2 W/(m-K).

15. The combination oven of claim 1 wherein the internal baffle has a density of approximately 2.7 to 3.0 g/cm³.

16. The combination oven of claim 1 wherein the internal baffle weighs approximately 500 to 900 g and has a volume of 200 to 300 cc.

17. The combination oven of claim 1 wherein an outer footprint of the combustion tube is cylindrical.

18. The combination oven of claim 1 wherein the combustion tube is at least one of aluminum, copper alloy, stainless steel, carbon steel, non-ferrous copper alloy, Inconel, nickel, Hastelloy and titanium.

19. The combination oven of claim 1 further comprising first and second end plates attached to opposed ends of the internal baffle respectively and form attachment collars at the opposed end of the internal baffle.
